(19) United States
(12) Patent Application Publication
(10) Pub. No.: US 2016/0361598 A1
(43) Pub. Date: Dec. 15, 2016

(54) SPORT ACTIVITY RECORDING APPARATUS AND SPORT ACTIVITY RECORDING METHOD

(71) Applicant: Seiko Epson Corporation, Tokyo (JP)

(72) Inventor: Mikio Nagahara, Yamagata-mura (JP)

(21) Appl. No.: 15/173,902

(22) Filed: Jun. 6, 2016

(30) Foreign Application Priority Data
Jun. 9, 2015 (JP) 2015-116406

(51) Int. Cl. A63B 24/00; G04G 21/02; A63B 71/06

(52) U.S. Cl. CPC A63B 24/0062; A63B 71/06; G04G 21/02

(57) ABSTRACT

A sport activity recording apparatus includes a clock that measures time, a position sensor that calculates a position, and a processor that initiates, when the measured time falls within a predetermined period including planned sport activity initiation time and the calculated position falls within a predetermined area including a planned sport activity initiation position, recording of the sport activity.

### CROSS-REFERENCE

This application claims priority to Japanese Patent Application No. 2015-116406, filed Jun. 9, 2015, the entirety of which is hereby incorporated by reference.

### BACKGROUND

1. Technical Field

The present invention relates to a sport activity recording apparatus, a sport activity recording method, a computer readable program, and others.

2. Related Art

There is a known apparatus that records a user's sport activity. For example, an apparatus that records mountain climbing logs (user's position and other histories during mountain climbing) initiates the recording at the timing when the user performs initiation operation, for example, at a point from which the user ascends a mountain and terminates the recording at the timing when the user performs termination operation, for example, at a point to which the user descends the mountain. However, if the user forgets to perform the initiation or termination operation, recorded contents are missing or incorrect.

As a time measurement apparatus for an automobile or any other object, there has been a proposed apparatus that initiates time measurement when an object under measurement departs from a start point of a course set in advance on map data and records the time when the object under measurement arrives at a goal point of the course (JP-A-2010-108231).

Using the time measurement apparatus in sport activities, for example, mountain climbing, however, the usability of the apparatus possibly deteriorates. For example, when a start point of a climbing route along which the user has planned to travel is located in a city area, the measurement is undesirably initiated simply when the user unintentionally passes by the start point.

### SUMMARY

An advantage of some aspects of the invention is to provide a sport activity recording apparatus, a sport activity recording method, and a computer readable program capable of appropriately initiating and terminating recording of a sport activity.

The invention can be implemented as the following forms or application examples.

### Application Example 1

A sport activity recording apparatus according to this application example includes a clock that measures time, a position sensor that calculates a position, and a processor that initiates, when the measured time falls within a predetermined period including planned sport activity initiation time and the calculated position falls within a predetermined area including a planned sport activity initiation position, recording of the sport activity.

The processor initiates the recording when the measured time falls within the predetermined period and the calculated position falls within the predetermined area. Therefore, for example, even when a user does not instruct the sport activity recording apparatus to initiate the recording, the recoding can be appropriately initiated. Further, since the processor uses both a period and a position, the possibility of inappropriate initiation of the recording can be lowered as compared with a case where only a period or a position is used. The sport activity recording apparatus can therefore lower the possibility of a large amount of omission of recorded data on the sport activity and useless recording (useless electric power consumption). The “time” in the present disclosure may include at least one of the year, month, date, hour, minute, second, and other parameters.

### Application Example 2

In the sport activity recording apparatus according to the application example, the processor may cause the position sensor to start operating when the measured time falls within the predetermined period.

The processor causes the position sensor to start operating when the measured time falls within the predetermined period. The recording can therefore be initiated, for example, after the position sensor starts operating and when the calculated position falls within the predetermined area.

### Application Example 3

In the sport activity recording apparatus according to the application example, the processor may not allow the position sensor to start operating when the measured time does not fall within the predetermined period.

The processor does not allow the position sensor to operate when the measured time does not fall within the predetermined period. The operation of the position sensor can therefore be restricted when the time does not fall within the predetermined period.

### Application Example 4

In the sport activity recording apparatus according to the application example, the processor may increase a frequency of action of the position sensor when the calculated position falls within an inclusion area that includes the predetermined area.

The processor increases the frequency of the action of the position sensor when the calculated position falls within the inclusion area, which is wider than the predetermined area. The calculation of a position included in the predetermined area can be quickly performed as compared with a case where the frequency is not increased.

### Application Example 5

In the sport activity recording apparatus according to the application example, the processor may not initiate the recording of the sport activity when the calculated position falls within the inclusion area but does not falls within the predetermined area.

The processor does not initiate the recording unless the calculated position falls within the predetermined area even when the calculated position falls within the inclusion area. The recording (or useless electric power consumption) in the case where the calculated position does not fall within the predetermined area can therefore be avoided.

### Application Example 6

In the sport activity recording apparatus according to the application example, the processor may evaluate whether or not the calculated position falls within the predetermined area at a predetermined frequency when the calculated position falls within the inclusion area.

The processor evaluates whether or not the calculated position falls within the predetermined area at a predetermined frequency when the calculated position falls within the inclusion area. The possibility of failure to detect timing when the calculated position enters the predetermined area can therefore be lowered.

### Application Example 7

In the sport activity recording apparatus according to the application example, the processor may reduce the frequency of the action of the position sensor when the position calculated after the calculated position falls within the inclusion area does not fall within the inclusion area.

The processor reduces the frequency of the action of the position sensor even when the calculated position once fell within the inclusion area but when the position calculated afterward does not fall within the inclusion area. The action of the position sensor in the case where the calculated position does not fall within the inclusion area can therefore be restricted.

### Application Example 8

A sport activity recording apparatus according to this application example includes a clock that measures time, a position sensor that calculates a position, and a processor that terminates, when the measured time falls within a predetermined period including planned sport activity termination time and the calculated position falls within a predetermined area including a planned sport activity termination position, recording of the sport activity.

The processor terminates the recording when the measured time falls within the predetermined period and the calculated position falls within the predetermined area. Therefore, even when the user does not instruct the sport activity recording apparatus to terminate the recording, the recoding can be appropriately terminated. Further, since the processor uses both a period and a position, the possibility of inappropriate termination of the recording can be lowered as compared with a case where only a period or a position is used. The sport activity recording apparatus can therefore lower the possibility of a large amount of omission of recorded data on the sport activity and useless recording (useless electric power consumption).

### Application Example 9

In the sport activity recording apparatus according to the application example, the processor may evaluate whether or not the calculated position falls within the predetermined area at a predetermined frequency when the measured time falls within the predetermined period.

The processor evaluates whether or not the calculated position falls within the predetermined area at a predetermined frequency when the measured time falls within the predetermined period. The possibility of failure to detect a situation in which the calculated position falls within the predetermined area can therefore be lowered.

### Application Example 10

In the sport activity recording apparatus according to the application example, a target of the recording may include the position calculated at each point of time during the sport activity.

The sport activity recording apparatus can therefore use the position sensor to record the sport activity.

### Application Example 11

The sport activity recording apparatus according to the application example may be attachable to a predetermined site of the user.

The user can therefore record the sport activity without the sport activity recording apparatus held by a hand.

### Application Example 12

In the sport activity recording apparatus according to the application example, the predetermined site may be an arm or a wrist.

The user can therefore use the electronic apparatus as if it were, for example, a wristwatch.

### Application Example 13

A sport activity recording method according to this application example includes initiating, when time measured by a clock falls within a predetermined period including planned sport activity initiation time and a position calculated by a position sensor falls within a predetermined area including a planned sport activity initiation position, recording of the sport activity.

In the sport activity recording method according to this application example, the recording is initiated when the measured time falls within the predetermined period including the planned initiation time and the calculated position falls within the predetermined area including the planned initiation position. Therefore, for example, even when the user does not instruct initiation of the recording, the recoding can be appropriately initiated. Further, since the method according to the present application example uses both a period and a position, the possibility of inappropriate initiation of the recording can be lowered as compared with a case where only a period or a position is used. The method according to the present application example can therefore lower the possibility of a large amount of omission of recorded data on the sport activity and useless recording (useless electric power consumption).

### Application Example 14

A sport activity recording method according to this application example includes terminating, when time measured by a clock falls within a predetermined period including planned sport activity termination time and a position calculated by a position sensor falls within a predetermined area including a planned sport activity termination position, recording of the sport activity.

In the sport activity recording method according to this application example, the recording is terminated when the measured time falls within the predetermined period including the planned termination time and the calculated position falls within the predetermined area including the planned termination position. Therefore, for example, even when the user does not instruct termination of the recording, the recoding can be appropriately terminated. Further, since the method according to the present application example uses both a period and a position, the possibility of inappropriate termination of the recording can be lowered as compared with a case where only a period or a position is used. The method according to the present application example can therefore lower the possibility of a large amount of omission of recorded data on the sport activity and useless recording (useless electric power consumption).

### Application Example 15

A computer readable program according to this application example causes the computer to initiate, when time measured by a clock falls within a predetermined period including planned sport activity initiation time and a position calculated by a position sensor falls within a predetermined area including a planned sport activity initiation position, recording of the sport activity.

That is, the computer readable program according to this application example initiates the recording when the measured time falls within the predetermined period including the planned initiation time and the calculated position falls within the predetermined area including the planned initiation position. Therefore, for example, even when the user does not instruct initiation of the recording, the recoding can be appropriately initiated. Further, since the program according to the present application example uses both a period and a position, the possibility of inappropriate initiation of the recording can be lowered as compared with a case where only a period or a position is used. The program according to the present application example can therefore lower the possibility of a large amount of omission of recorded data on the sport activity and useless recording (useless electric power consumption).

### Application Example 16

A computer readable program according to this application example causes the computer to terminate, when time measured by a clock falls within a predetermined period including planned sport activity termination time and a position calculated by a position sensor falls within a predetermined area including a planned sport activity termination position, recording of the sport activity.

That is, the computer readable program according to this application example terminates the recording when the measured time falls within the predetermined period including the planned termination time and the calculated position falls within the predetermined area including the planned termination position. Therefore, for example, even when the user does not instruct termination of the recording, the recoding can be appropriately terminated. Further, since the program according to the present application example uses both a period and a position, the possibility of inappropriate termination of the recording can be lowered as compared with a case where only a period or a position is used. The program according to the present application example can therefore lower the possibility of a large amount of omission of recorded data on the sport activity and useless recording (useless electric power consumption).

### BRIEF DESCRIPTION OF THE DRAWINGS

The invention will be described with reference to the accompanying drawings, wherein like numbers reference like elements.

FIG. 1 describes an overview of an electronic apparatus according to a first embodiment.

FIG. 2 is a functional block diagram for describing the configuration of a system including the electronic apparatus.

FIG. 3 describes an example of how a user specifies a route.

FIG. 4 describes mountain climbing plan data.

FIG. 5 is a flowchart for describing the action of an information terminal in preparation for mounting climbing.

FIG. 6 is a flowchart for describing logging-initiation-process-related action of the electronic apparatus.

FIG. 7 is flowchart for describing logging-termination-process-related action of the electronic apparatus.

FIG. 8 is flowchart for describing sleep-period-determination-process-related action of the electronic apparatus.

### DESCRIPTION OF EXEMPLARY EMBODIMENTS

A preferable embodiment of the invention will be described below in detail with reference to the drawings. The embodiment described below is not intended to unduly limit the contents of the invention set forth in the appended claims. Further, all configurations described below are not necessarily essential configuration requirements of the invention.

### 1. Embodiment of Electronic Apparatus

### 1-1. Overview of Electronic Apparatus

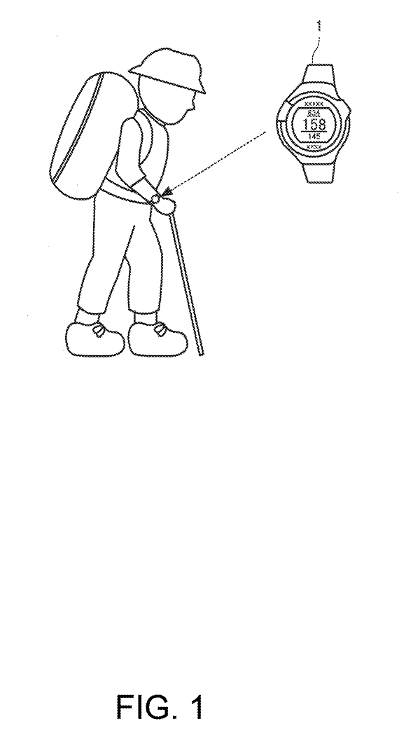

FIG. 1 describes an overview of an electronic apparatus according to a first embodiment.

An electronic apparatus (example of sport activity recording apparatus) 1 according to the present embodiment is, for example, a mobile information apparatus attached to part of a user's body in an outdoor event, such as mountain climbing, as shown in FIG. 1. A body part to which the electronic apparatus 1 is attached is, for example, a site in any position from the elbow to the hand (forearm) so that the electronic apparatus 1 is visible to the user whenever necessary. In the example shown in FIG. 1, the electronic apparatus 1 is configured as a wrist-worn-type (wristwatch-type) mobile information apparatus (outdoor watch), and the site to which the electronic apparatus 1 is attached is the wrist.

The electronic apparatus 1 is provided with a positioning function, a compass function, an atmospheric pressure detection function, a pulse detection function, and a variety of other sensing functions as well as a clock function. The following description will be made on the assumption that the electronic apparatus 1 is used in mountain climbing.

The electronic apparatus 1 uses the sensing functions to perform logging (example of recording of sport activity) associated with the user's mountain climbing activity (example of sport activity). The term “logging associated with the user's mountain climbing activity” refers to logging of quantities representing at least part of the user's mountain climbing activity, for example, the latitude, longitude, altitude, velocity, direction, atmospheric pressure, heart rate per unit time, the number of steps per unit time, body temperature, air temperature, sweat rate, humidity, the amount of ultraviolet rays per unit time, and a variety of other sensed data. The term “logging” further refers to acquisition of a history of data (that is, recording of data in a time series form or in an individual data identifiable form).

In preparation for mountain climbing, the user operates an information terminal, such as a smartphone, a tablet PC, and a desktop PC, to register a mountain climbing plan, such as a planned climbing route, in the electronic apparatus 1 via the information terminal. The user does not need to operate any apparatus (such as information terminal) other than the electronic apparatus 1 on the day of the mountain climbing to register the mountain climbing plan as long as the user registers the mountain climbing plan in the preparation for the mountain climbing.

On the day of the mountain climbing, when the user who carries (wears) the electronic apparatus 1 starts the mountain climbing along the route contained in the mountain climbing plan, the electronic apparatus 1 initiates the logging. When the mountain climbing along the route is completed, the electronic apparatus 1 terminates the logging.

The user therefore does not need to input a logging initiation instruction to the electronic apparatus 1 when the user starts the mountain climbing or input a logging termination instruction to the electronic apparatus 1 when the user completes the mountain climbing as long as the user registers the mountain climbing plan in advance.

Further, since the electronic apparatus 1 can avoid a situation in which the user forgets to input the initiation instruction and log data is therefore missing, a considerable decrease in accuracy of general or statistical data calculated from overall log data can be avoided. The term “general data” used herein refers to the period required for the mountain climbing, cumulative travel distance, cumulative steps, cumulative ascending altitude, cumulative descending altitude, the amount of ultraviolet rays, and other data. The term “statistical data” used herein refers to the average pace during the mountain climbing, average pace per predetermined period, average pace per predetermined distance, and other data. The segment over which the general data is calculated and the segment over which the statistical data is calculated may, for example, be the entire travel route of the mountain climbing, the segment from the initiation point to the current point, a partial segment of the travel route, and the segment from the initiation point of the partial segment to the current point. Since the electronic apparatus 1 can avoid useless logging performed when the user forgets to input the termination instruction, useless electric power consumption can be avoided.

### 1-2. Registration of Mountain Climbing Plan

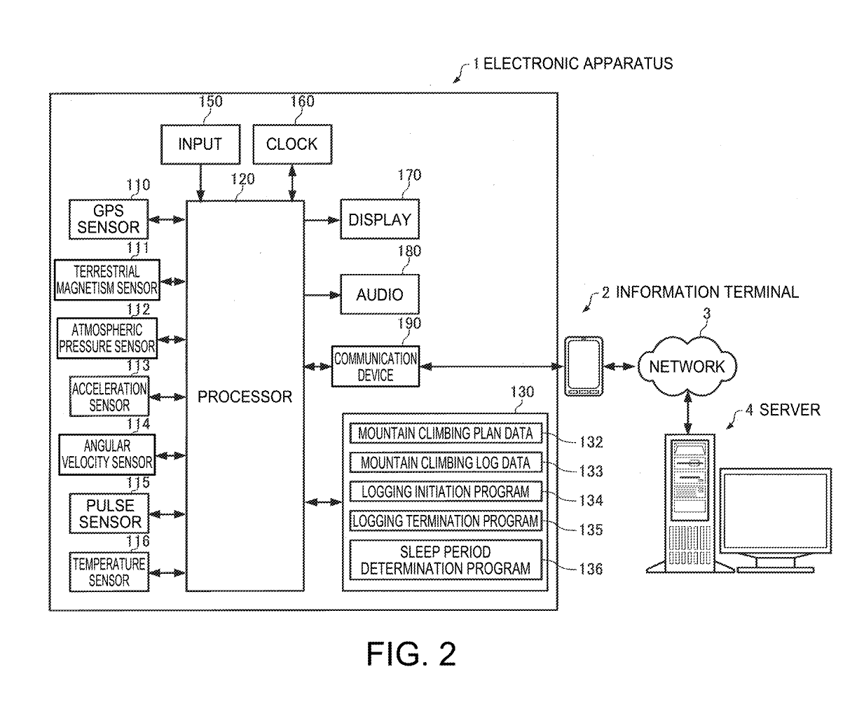

In the preparation for mountain climbing, the electronic apparatus 1 is connected to an information terminal 2, and the information terminal 2 is connected to a network 3, such as the Internet, as shown, for example, in FIG. 2. The following description will be made on the assumption that a touch panel is used as a user interface of the information terminal 2.

The user first operates the information terminal 2 to access a network server 4, causes the network server 4, which stores a world atlas, to display a map of a desired area on the display screen (such as tough-panel-type display) of the information terminal 2, and views the map. The user then enlarges, reduces, scrolls, and otherwise processes the map on the information terminal 2 and causes the information terminal 2 to display an area including a planned route.

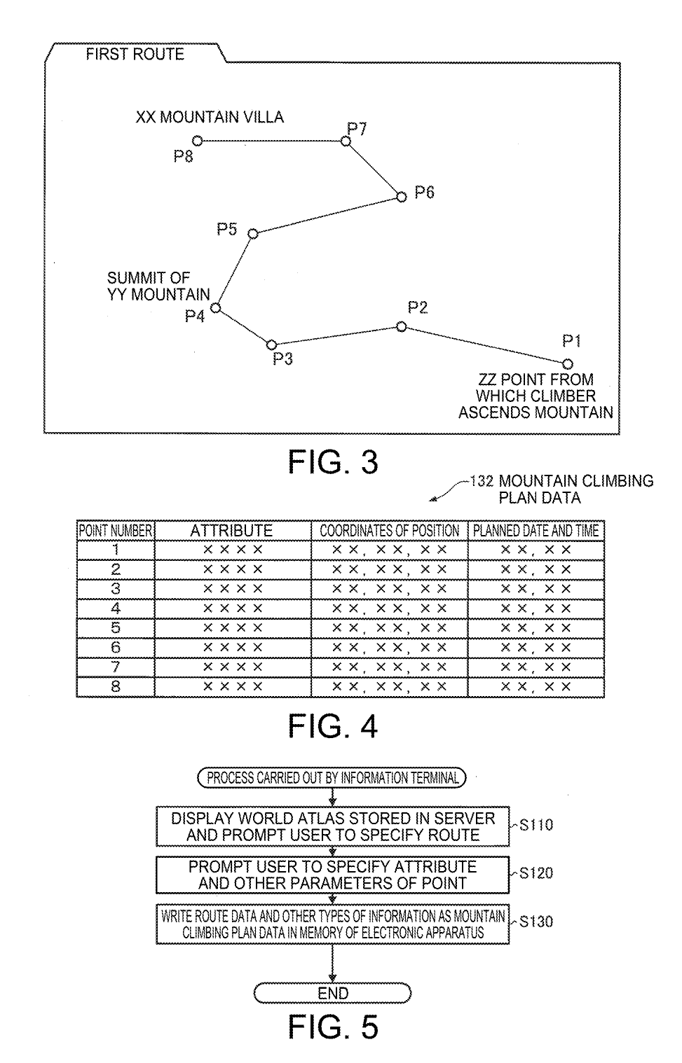

The user then specifies (touches) points P1, P2, P3, . . . on the route sequentially from the start point P1 of the route, as shown, for example, in FIG. 3. When the user completes the specification of a goal point of the route (point P8 in FIG. 3), the user inputs a completion notification to the information terminal 2.

Each of the “points” used herein is a position on the route. Therefore, the “points” may include points where a user plans to do some events (such as rest and lunch) (event points), may include a point where another route branches off, or may include any other point.

The information terminal 2 connects the plurality of points P1, P2, P3, . . . specified by the user to each other in the order in which they have been specified to create a route, takes the created route as a route specified by the user, and downloads a local map (including topographic data) that includes the route from the network server 4.

The information terminal 2 may take a zigzag route created by connecting the plurality of points P1, P2, P3, . . . to each other in the order in which they have been specified as the route specified by the user, may take a smooth curved route created by interpolating or smoothing the zigzag route as the route specified by the user, or may take the center line of a route on the map that is closest to the zigzag route as the route specified by the user.

The user can therefore specify a route with no crossing or traffic sign, as in the case of a climbing route, in the information terminal 2.

The information terminal 2 extracts the coordinates (latitude, longitude, and altitude) of the positions of the plurality of points P1, P2, P3, . . . located on the route specified by the user from the topographic data contained in the local map and creates data on the route in the form of data created by arranging the coordinates of the positions of the plurality of points P1, P2, P3, . . . in the order of the point number. For example, data on the route shown in FIG. 3 therefore includes the coordinates (latitude, longitude, and altitude) of the positions of at least the eight points P1 to P8.

The coordinates (latitude, longitude, and altitude) of the position of a point Pn are the coordinates representing the absolute position of the point Pn on the earth.

When the user desires to reflect a detailed shape of the route in the route data, the user only needs to increase the number of points specified on the map. For example, when the user desires to reflect information on ups and downs of the route in the route data, the user only needs to at least specify one or more peak points on the route and one or more valley points on the route.

When specifying a route, the user also inputs attributes of a plurality of points that form the route to the information terminal 2. Examples of a point with an attribute may include “a rest point,” “a lunch point,” “a branch point,” and “a photographing point,” and the attribute is, for example, an event name or a comment inputted by the user. The attribute of a point may be inputted, for example, in the form of a text or by selection of any of a plurality of icons (marks) prepared in advance.

When specifying a route, the user also inputs the name of the route, the date and time at which the user has planned to pass each point, and other types of information to the information terminal 2. The name and the date and time are inputted, for example, in the form of a text (numerals).

The information terminal 2 then creates mountain climbing plan data including the data on the route specified by the user and the attributes (such as planned date and time) of the points that form the route. FIG. 4 is a visualized example of the structure of the mountain climbing plan data.

It is not essential to input a planned date and time for each of the points that form the route, and inputting at least the following two points may suffice: the start point of the route; and the goal point of the route. The start point of the route is, for example, a point from which the user ascends the mountain, and the goal point of the route is, for example, “an XX mountain villa,” at which the user has planned to lodge, or a point from which the user descends the mountain.

As long as the user has inputted a planned date and time at the start point, the user may not input a planned date and time at another point but may input, for example, an elapsed period (such as two hours, three hours) since the start from the start point.

### 1-3. Configurations of Electronic Apparatus and Others

FIG. 2 is a functional block diagram for describing the configuration of a system including the electronic apparatus.

The electronic apparatus 1 includes a GPS sensor (example of position sensor) 110, a terrestrial magnetism sensor 111, an atmospheric pressure sensor 112, an acceleration sensor 113, an angular velocity sensor 114, a pulse sensor 115, a temperature sensor 116, a processor 120, a memory 130, an input 150, a clock 160, a display 170, an audio 180, a communication device 190, and other components, as shown in FIG. 2. In the configuration of the electronic apparatus 1, however, part of the constituent elements described above may be omitted or changed, or another constituent element (humidity sensor, ultraviolet ray sensor, for example) may be added.

The GPS sensor 110 is a sensor that produces positioning data (data on latitude, longitude, altitude, velocity vector, and other quantities) representing the position of the electronic apparatus 1 and outputs the positioning data to the processor 120, and the GPS sensor 110 includes, for example, a GPS (global positioning system) receiver and other components. The GPS sensor 110 receives an externally incoming electromagnetic wave that belongs to a predetermined frequency band via a GPS antenna that is not shown, extracts a GPS signal from a GPS satellite, and produces the positioning data representing the position and other parameters of the electronic apparatus 1 on the basis of the GPS signal.

The terrestrial magnetism sensor 111 is a sensor that detects a terrestrial magnetism vector representing the terrestrial magnetic field direction viewed from the electronic apparatus 1 and produces, for example, terrestrial magnetism data representing magnetic flux densities in three axial directions perpendicular to each other. The terrestrial magnetism sensor 111 is, for example, an MR (magnet resistive) element, an MI (magnet impedance) element, or a Hall element.

The atmospheric pressure sensor 112 is a sensor that detects the surrounding atmospheric pressure (barometric pressure) and has, for example, a pressure sensitive element operating on the basis of a method using a change in the resonance frequency of a vibrating piece (vibration method). The pressure sensitive element is a piezoelectric vibrator made, for example, of quartz, lithium niobate, lithium tantalate, or any other piezoelectric material and is, for example, a tuning-fork-type vibrator, a dual-tuning-fork-type vibrator, an AT vibrator (thickness shear vibrator), or an SAW resonator. The output from the atmospheric pressure sensor 112 may be used to correct the positioning data.

The acceleration sensor 113 is an inertia sensor that detects acceleration in each of three axial directions that intersect each other (ideally perpendicular to each other) and outputs a digital signal according to the magnitude and direction of the detected acceleration in each of the three axes (acceleration data). The output from the acceleration sensor 113 may be used to correct the positional information contained in the positioning data from the GPS sensor 110.

The angular velocity sensor 114 is an inertia sensor that detects angular velocity in each of the three axial directions that intersect each other (ideally perpendicular to each other) and outputs a digital signal according to the magnitude and direction of the measured angular velocity in each of the three axes (angular velocity data). The output from the angular velocity sensor 114 may be used to correct the positional information contained in the positioning data from the GPS sensor 110.

The pulse sensor 115 is a sensor that produces a signal representing the user's pulse and outputs the signal to the processor 120. The pulse sensor 115 includes, for example, an LED light source or any other light source that emits measurement light having an appropriate wavelength toward a subcutaneous blood vessel and a light receiving device that detects a change in the intensity of light produced at the blood vessel in response to the measurement light.

The temperature sensor 116 is a temperature sensitive element that outputs a signal according to the surrounding temperature (voltage according to temperature, for example). The temperature sensor 116 may instead be a sensor that outputs a digital signal according to the temperature.

The processor 120 is formed, for example, of an MPU (micro processing unit), a DSP (digital signal processor), and an ASIC (application specific integrated circuit). The processor 120 carries out a variety of processes in accordance with a program stored in the memory 130 and a variety of commands inputted by the user via the input 150. The processes carried out by the processor 120 include data processing in which data produced by the GPS sensor 110, the terrestrial magnetism sensor 111, the atmospheric pressure sensor 112, the acceleration sensor 113, the angular velocity sensor 114, the pulse sensor 115, the temperature sensor 116, the clock 160, and other components are processed, display processing in which the display 170 is caused to display an image, audio processing in which the audio 180 is caused to output audio, and other types of processing.

The memory 130 is formed, for example, of one or more IC memories and has a ROM that memorizes programs and other types of data and a RAM that serves as a work area used by the processor 120. The RAM includes a nonvolatile RAM, and the nonvolatile RAM provides a memory area, where mountain climbing plan data 132, mountain climbing log data 133, and other types of data are memorized. The programs memorized in the ROM include programs associated with the logging, such as a logging initiation program 134, a logging termination program 135, and a sleep period determination program 136 (also include a program associated with the logging itself, although not shown).

The input 150 is formed, for example, of buttons, keys, a microphone, a touch panel, a voice recognition function (using microphone that is not shown), and an action detection function (using acceleration sensor 113 and others), converts an instruction from the user into an appropriate signal, and transmits the signal to the processor 120.

The clock 160 is formed, for example, of a real-time clock (RTC) IC, produces time data, such as the year, month, date, hour, minute, and second, and transmits the time data to the processor 120.

The display 170 is formed, for example, of an LCD (liquid crystal display), an organic EL (electroluminescence) display, an EPD (electrophoretic display), or a tough-panel-type display and displays a variety of images in accordance with an instruction from the processor 120.

The audio 180 is formed, for example, of a loudspeaker, a buzzer, or a vibrator and produces a variety of type of audio (or vibration) in accordance with an instruction from the processor 120.

The communication device 190 performs a variety of types of control for establishing data communication between the electronic apparatus 1 and the information terminal 2 (such as smartphone). The communication device 190 includes a transceiver that complies, for example, with Bluetooth (registered trademark) (including BTLE: Bluetooth Low Energy), Wi-Fi (registered trademark) (Wi-Fi: wireless fidelity), Zigbee (registered trademark), NFC (near field communication), ANT+ (registered trademark), and other short-distance wireless communication standards.

The information terminal 2 is a smartphone, a tablet PC, a desktop PC, or any other information terminal connectable to the network 3, such as the Internet, and incorporates a communication device that is not shown but corresponds to the communication device 190 of the electronic apparatus 1. A program for controlling the electronic apparatus 1 is installed in a memory (not shown) of the information terminal 2, and the information terminal 2, when connected at least to the electronic apparatus 1, operates in accordance with the program. The program is, for example, downloaded from the network server 4 over the network 3, such as the Internet.

The network server 4 is a network server connected to the network 3, such as the Internet. The network server 4 is provided with a function of managing data and other types of information uploaded from the user of the electronic apparatus 1 on a user basis. The network server 4 is further provided with a function of providing the user of the electronic apparatus 1 with a program and map data.

### 1-4. Process Carried Out by Information Terminal

FIG. 5 is a flowchart for describing a process carried out by the information terminal 2 in the preparation for mounting climbing. In the preparation, it is assumed that the information terminal 2 is connected to the network 3 and the electronic apparatus 1. The steps in FIG. 5 will be sequentially described below.

Step S110: The information terminal 2 displays the world atlas stored in the network server 4 and prompts the user to specify a route on the map. How the user specifies a route has been described above (see FIG. 3).

Step S120: The information terminal 2 prompts the user to specify the attribute (including planned date and time) of each point that forms the route.

Step S130: The information terminal 2 prepares mountain climbing plan data including data on the route and the attribute of each point on the route (see FIG. 4), writes the mountain climbing plan data as the mountain climbing plan data 132 in the memory 130 of the electronic apparatus 1, and terminates the mountain climbing preparation process. The mountain climbing plan has thus been registered.

### 1-5. Processes Carried Out by Electronic Apparatus

### 1-5-1. Logging Initiation Process

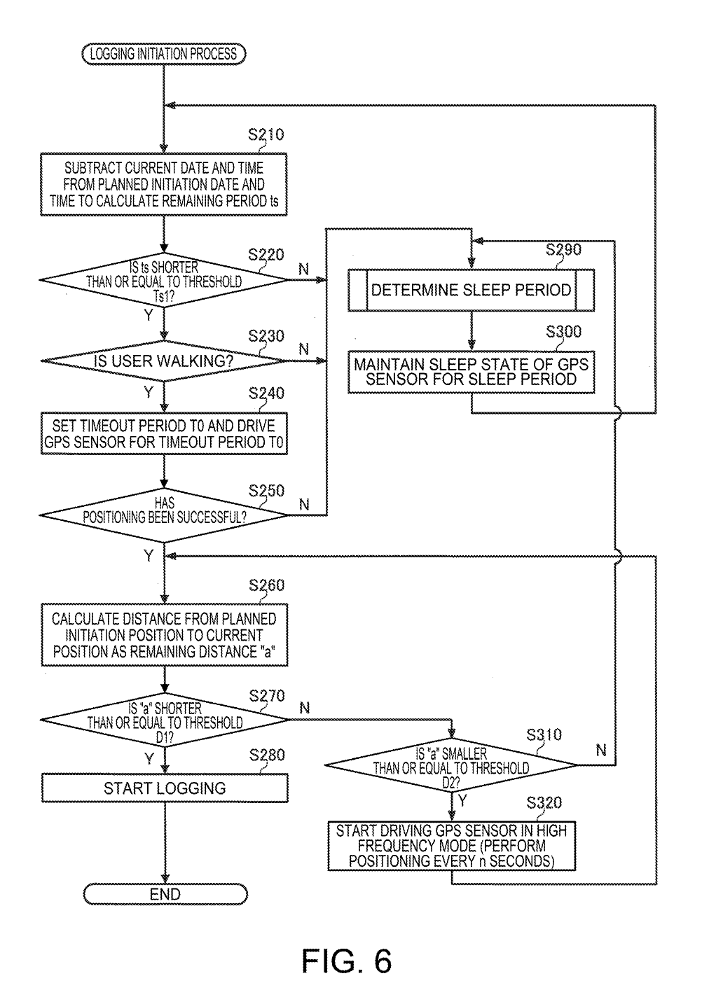

FIG. 6 is a flowchart for describing logging-initiation-process-related action of the electronic apparatus 1. The logging initiation process is carried out by the processor 120 in accordance with the logging initiation program 134.

The following description will be made on the assumption that the user on the day of the mountain climbing carries the electronic apparatus 1 and acts in accordance with the registered mountain climbing plan. It is, however, noted that the user's action does not need to completely coincide with the mountain climbing plan and occurrence of delay and other unplanned acts to some extent do not matter.

The logging initiation process is initiated by the time when the user arrives at the start point of the route contained in the mountain climbing plan and, for example, at the point of time when the user wears the electronic apparatus 1 and a solar battery or any other power source that is not shown starts supplying the processor 120 and other components with sufficient electric power. It is, however, noted that the steps in FIG. 6 will be sequentially described on the assumption that at the beginning after the logging initiation program 134 is initiated, no electric power is supplied to the GPS sensor 110 (GPS sensor 110 is in a sleep state).

Step S210: The processor 120 refers to the mountain climbing plan data 132 stored in the memory 130 and recognizes the planned date and time related to the start point of the route as a planned logging initiation date and time. The processor 120 further refers to the time data outputted from the clock 160 to recognize the current time (example of measured time and including data, for example, on the year, month, date, hour, minute, and second). The processor 120 then subtracts the current date and time from the planned initiation date and time to calculate a remaining period ts, which is the period from the current date and time to the planned initiation date and time.

Step S220: The processor 120 evaluates whether or not the remaining period ts is shorter than or equal to a predetermined threshold Ts1. When a result of the evaluation shows that the remaining period ts is smaller than or equal to the threshold Ts1, the processor 120 proceeds to step S230, whereas when a result of the evaluation shows that the remaining period ts is not shorter than or equal to the threshold Ts1, the processor 120 proceeds to step S290. The threshold Ts1 [sec] for evaluating the remaining period ts [sec] is, for example, set at 1800 [sec].

Step 230: The processor 120 refers to the acceleration data outputted from the acceleration sensor 113 to evaluate whether or not the user is walking. When a result of the evaluation shows that the user is walking (Y in step S230), the processor 120 proceeds to step S240, where the GPS sensor 110 is driven, whereas when a result of the evaluation does not show that the user is walking (N in step S230), the processor 120 proceeds to step S290, where the GPS sensor 110 is caused to remain in the sleep state.

Whether or not the user is walking can be evaluated, for example, by evaluation of whether or not a waveform component specific to walking has appeared in the time-course waveform of the vertical component of the acceleration data outputted from the acceleration sensor 113. The evaluation can instead be made more simply, for example, by evaluation of whether or not the vertical component of the acceleration data exceeds a predetermined threshold.

Step S240: The processor 120 sets a timeout period T0 and drives the GPS sensor 110 for the timeout period T0 (Electric power supply to the GPS sensor 110 is initiated to bring the GPS sensor 110 into in a running state). When the GPS sensor 110 has successfully received a necessary number of GPS signals each having necessary magnitude, the GPS sensor 110 outputs positioning data (data on latitude, longitude, altitude, velocity vector, and other quantities), whereas when the GPS sensor 110 has failed to receive the GPS signals, the GPS sensor 110 outputs no positioning data. Therefore, when the GPS sensor 110 has outputted positioning data before the timeout period T0 elapses, the processor 120 acquires the positioning data and stops supplying the GPS sensor 110 with electric power (causes the GPS sensor 110 to transition to the sleep state).

On the other hand, when the GPS sensor 110 has outputted no positioning data before the timeout period T0 elapses, the processor 120 stops supplying the GPS sensor 110 with electric power at the point of time when the timeout period T0 elapses (causes the GPS sensor 110 to transition to the sleep state).

Step S250: The processor 120 evaluates whether or not positioning data has been successfully acquired in step S240. When a result of the evaluation shows successful acquisition, the processor 120 determines that the GPS sensor 110 has succeeded in positioning (Y in step S250), and the processor 120 proceeds to step S260, whereas when a result of the evaluation does not shows that the GPS sensor 110 has successfully outputted positioning data, the processor 120 determines that the GPS sensor 110 has failed to perform positioning (N in step S250), and the processor 120 proceeds to step S290.

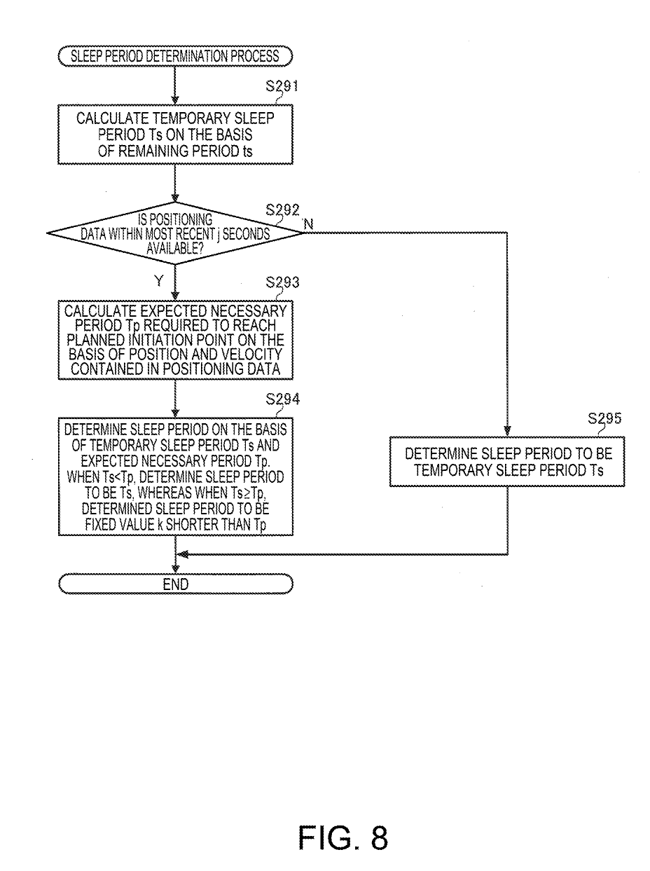

Step S290: The processor 120 carries out a sleep period determination process (FIG. 8) to determine a standby period for which the GPS sensor 110 is caused to return from the sleep state to the running state (sleep period for which the GPS sensor 110 is in the sleep state). The sleep period determination process will be described later in detail.

Step S300: The processor 120 maintains the sleep state of the GPS sensor 110 and transitions to step S210 after the period equal to the sleep period determined in step S290 elapses.

Therefore, at least when the current date and time has not so approached the planned initiation date and time that they are not close enough to each other (N in step S220), the processor 120 drives the GPS sensor 110 in a low frequency mode. The low frequency mode is a mode in which the GPS sensor 110 is driven with the sleep period (step S300) sandwiched between positioning attempts (positioning retrials). The frequency of positioning in the low frequency mode is lower than the frequency of positioning in a high frequency mode in step S320.

Step S260: The processor 120 refers to the mountain climbing plan data 132 and recognizes the coordinates of the position related to the start point of the route as a planned logging initiation position. The processor 120 then calculates the distance from the planned initiation position to the current position as a remaining distance “a”. The current position (example of calculated position) is expressed by the latitude, longitude, altitude, and other parameters contained in the latest positioning data acquired by the processor 120.

Step S270: The processor 120 evaluates whether or not the remaining distance “a” is shorter than a predetermined threshold D1. When a result of the evaluation shows that the remaining distance “a” is shorter than or equal to the threshold D1 (Y in step S270), the processor 120 proceeds to step S280, whereas when a result of the evaluation does not show that the remaining distance “a” is shorter than or equal to the threshold D1 (N in step S270), the processor 120 proceeds to step S310. The threshold D1 [m] for evaluating the remaining distance “a” [m] is set, for example, at 100 [m].

Step S280: The processor 120 starts the logging and terminates the logging initiation process.

When the logging is initiated, the processor 120 drives the GPS sensor 110 in a high frequency mode. The high frequency mode is, for example, not only a mode in which the GPS sensor 110 is continuously driven but also a mode in which the GPS sensor 110 outputs positioning data (performs positioning) in predetermined time intervals (every n seconds) (n=1, for example). The positioning frequency in the high frequency mode during the logging is, for example, equal to the positioning frequency in the high frequency mode in step S320, which will be described later.

Step S310: The processor 120 evaluates whether or not the remaining distance “a” is shorter than a predetermined threshold D2, which is longer than the threshold D1 (D1<D2). When a result of the evaluation shows that the remaining distance “a” is shorter than or equal to the threshold D2 (Y in step S310), the processor 120 proceeds to step S320, whereas when a result of the evaluation does not show that the remaining distance “a” is shorter than or equal to the threshold D2 (N in step S310), the processor 120 proceeds to step S290, where the GPS sensor 110 is brought into the sleep state until the GPS sensor 110 is required to be driven. The threshold D2 [m] for evaluating the remaining distance “a” [m] is set, for example, at 500 [m].

Step S320: The processor 120 starts driving the GPS sensor 110 in the high frequency mode. The high frequency mode is, for example, not only a mode in which the GPS sensor 110 is continuously driven but also a mode in which the GPS sensor 110 outputs positioning data (performs positioning) in predetermined time intervals (every n seconds) (n=1, for example). The positioning frequency in the high frequency mode in step S320 is higher than the positioning frequency in the low frequency mode described above. The positioning frequency in the high frequency mode in step S320 is, for example, equal to the positioning frequency in the high frequency mode during the logging (n=1). The positioning frequency in the high frequency mode in step S320 may differ from the positioning frequency in the high frequency mode during the logging.

Therefore, when the current position has so approached the planned initiation position that the distance between them is smaller than or equal to a fixed value (Y in step S310), the processor 120 drives the GPS sensor 110 in the high frequency mode, whereas when the current position has not so approached the planned initiation position that the distance between them is smaller than or equal to the fixed value (N in step S310), the processor 120 drives the GPS sensor 110 in the low frequency mode.

### 1-5-2. Process During Logging

Although not shown in detail in FIG. 6, the processor 120 performs the logging in the following procedures (1) to (4). During the logging, a variety of sensors, such as the GPS sensor 110, the terrestrial magnetism sensor 111, the atmospheric pressure sensor 112, the acceleration sensor 113, the angular velocity sensor 114, the pulse sensor 115, and the temperature sensor 116, may be driven more frequently than before and after the logging (continuously driven, for example).

(1) The processor 120 refers to (samples) data outputted from a variety of sensors, such as the GPS sensor 110, the terrestrial magnetism sensor 111, the atmospheric pressure sensor 112, the acceleration sensor 113, the angular velocity sensor 114, the pulse sensor 115, and the temperature sensor 116.

(2) The processor 120 performs necessary processing on at least part of the data having been sampled (sampled data) to produce sensed data, such as the latitude, longitude, altitude, velocity, direction, atmospheric pressure, heart rate per unit time, the number of steps per unit time, and body temperature (that is, data representing contents of user's sport activity).

(3) The processor 120 attaches the time data outputted from the clock 160 to the produced sensed data to produce log data at the current time and writes the log data at the current time in mountain climbing log data 133 in the memory 130.

(4) The processor 120 repeats a series of processes including the procedures (1), (2), and (3) at predetermined time intervals (1-second time intervals, for example).

Log data at each point of time is therefore successively (at predetermined time intervals) accumulated in the mountain climbing log data 133. The log data at each point of time written in the mountain climbing log data 133 is not limited to those described above. For example, the log data at each point of time may be sampled data itself from each of the variety of sensors (that is, data before processing). When a signal outputted from at least part of the variety of sensors is an analog signal, the processor 120 performs A/D conversion on the analog signal before the signal outputted from the part of the variety of sensors is sampled (procedure (1)).

### 1-5-3. Logging Termination Process

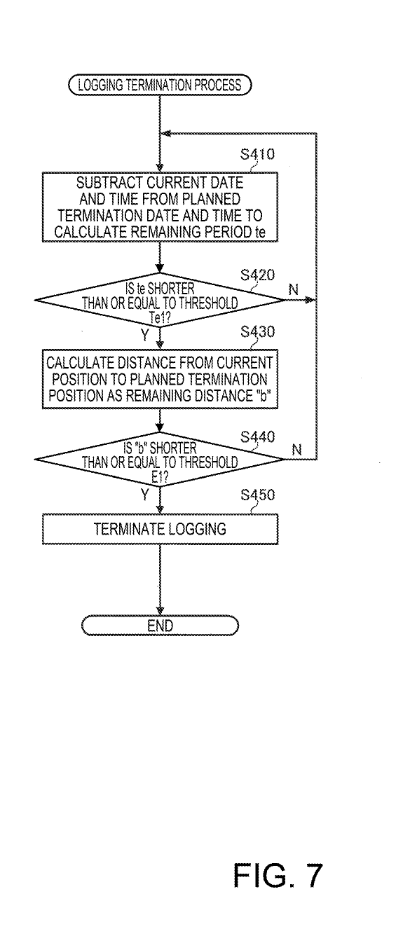

FIG. 7 is a flowchart for describing logging-termination-process-related action of the electronic apparatus 1. The logging termination process is carried out by the processor 120 in accordance with the logging termination program 135.

The logging termination process is initiated anytime in the period from the time when the user initiates the logging to the time when the user arrives at the goal point of the route contained in the mountain climbing plan, and the logging termination timing is, for example, the beginning of the initiated logging. The steps in FIG. 7 will therefore be described on the assumption that the GPS sensor 110 is driven in the high frequency mode at least at the beginning after the logging termination process is initiated.

Step S410: The processor 120 refers to the mounting climbing plan data 132 stored in the memory 130 to recognize the planned date and time related to the goal point of the route as planned logging termination date and time. The processor 120 further refers to the time data outputted from the clock 160 to recognize the current date and time. The processor 120 then subtracts the current date and time from the planned termination date and time to calculate a remaining period te, which is the period from the current date and time to the planned termination date and time.

Step S420: The processor 120 evaluates whether or not the remaining period te is shorter than or equal to a predetermined threshold Te1. When a result of the evaluation shows that the remaining period te is shorter than or equal to threshold Te1 (Y in step S420), the processor 120 proceeds to step S430, whereas when a result of the evaluation shows that the remaining period te is not shorter than or equal to the threshold Te1 (N in step S420), the processor 120 proceeds to step S410. The threshold Te1 is desirably set at a large value in accordance, for example, with the length of a planned mountain climbing period ((planned mountain climbing period)=(planned termination date and time)−(planned initiation date and time or actual initiation date and time)). The threshold Te1 is therefore calculated, for example, by division of the planned mountain climbing period by a predetermined value n′ (n′=3, for example).

Step S430: The processor 120 refers to the mountain climbing plan data 132 and recognizes the coordinates of the position related to the goal point of the route as a planned logging termination position. The processor 120 then calculates the distance from the current position to the planned termination position as a remaining distance “b”. The current position is expressed by the latitude, longitude, altitude, and other parameters contained in the latest positioning data acquired by the processor 120.

Step S440: The processor 120 evaluates whether or not the remaining distance “b” is shorter than or equal to a predetermined threshold E1. When a result of the evaluation shows that the remaining distance “b” is shorter than or equal to the threshold E1 (Y in step S440), the processor 120 proceeds to step S450, whereas when a result of the evaluation does not show that the remaining distance “b” is shorter than or equal to the threshold E1 (NY in step S440), the processor 120 proceeds to step S410. The threshold E1 [m] for evaluating the remaining distance “b” [m] is set, for example, at 100 [m]. (For example, the threshold E1 is set to be roughly equal to the threshold D1.)

Step S450: The processor 120 terminates the logging and terminates the logging termination process.

### 1-5-4. Sleep Period Determination Process

FIG. 8 is flowchart for describing sleep-period-determination-process-related action of the electronic apparatus 1. The sleep period determination process is carried out by the processor 120 in accordance with the sleep period determination program 136.

Step S291: The processor 120 calculates a temporary sleep period Ts on the basis of the remaining period ts from the current date and time to the planned initiation date and time. The temporary sleep period Ts is calculated, for example, by division of the remaining period ts by a predetermined value m (m=3, for example).

When the processor 120 has successfully acquired positioning data in step S240 immediately before step S291, the latitude, longitude, and altitude contained in the positioning data may be used to calculate the temporary sleep period Ts.

Step S292: The processor 120 evaluates whether or not positioning data within most recent j seconds has been successfully acquired. When a result of the evaluation shows successful acquisition (Y in step S292), the processor 120 proceeds to step 293, whereas when a result of the evaluation does not show successful acquisition (N in step S292), the processor 120 proceeds to step 295.

Step S293: The processor 120 calculates an expected necessary period Tp required to travel from the current position to the planned initiation position on the basis of the position and the velocity vector contained in the positioning data within the most recent j seconds. The expected necessary period Tp is calculated, for example, by division of the remaining distance “a” from the current position to the planned initiation position by the magnitude of the average velocity within the most recent j seconds.

Step S294: The processor 120 determines the sleep period on the basis of the temporary sleep period Ts and the expected necessary period Tp and terminates the sleep period determination process.

For example, when the temporary sleep period Ts is shorter than the expected necessary period Tp (Ts<Tp), the processor 120 concludes that even when the temporary sleep period Ts is used as the sleep period, the user could not reach the planned initiation position during the sleep period and uses the temporary sleep period Ts as the sleep period (determines the sleep period to be equal to the temporary sleep period Ts).

On the other hand, when the temporary sleep period Ts is longer than or equal to the expected necessary period Tp (Ts≧Tp), the processor 120 concludes that when the temporary sleep period Ts is used as the sleep period, the user could reach the planned initiation position during the sleep period and determines the sleep period to be a fixed value k shorter than the expected necessary period Tp (k=1 [sec], for example).

Step S295: The processor 120 uses the temporary sleep period Ts as the sleep period (determines the sleep period to be equal to the temporary sleep period Ts) and terminates the sleep period determination process.

In the sleep period determination process described above, the processor 120 may limit the sleep period to a value within a predetermined range (range from 1 to 5 minutes, for example).

### 2. Supplementary Description of Embodiment

The processor 120 in step S230 described above evaluates whether or not the user is walking. Instead, the processor 120 in step S230 may evaluate whether or not the user is moving instead of evaluating whether or not the user is walking.

Further, the processor 120 in step S230 described above uses the acceleration sensor 113 to evaluate whether or not the user is walking or moving and may instead use at least one of the acceleration sensor 113, the angular velocity sensor 114, and the GPS sensor 110 or a combination of two or more thereof.

When the GPS sensor 110 is used to evaluate whether or not the user is walking or moving, the evaluation step S230 may to be placed in the position downstream of step S250, where whether or not positioning has been successful, (necessarily on the Y-side of step S250).

The information terminal 2 in the embodiment described above, when it prompts the user to specify a route, prompts the user to specify a specific shape of the route (positional relationship between a plurality of points on the route), but the information terminal 2 may instead prompt the user to specify one of existing routes that are open to the public over the network 3 or one of existing routes that the network server 4 discloses to the user.

The processor 120 in the embodiment described above sets the start point of a registered route to be the planned logging initiation position and the goal point of the route to be the planned logging termination position and may instead set a halfway point on the route to be the planned logging initiation position or may instead set a halfway point on the route to be the planned logging termination position. Further, the processor 120 may allow the user to specify at least one of the planned initiation position and the planned termination position on the route.

The processor 120 in the embodiment described above uses the output from the GPS sensor 110 to calculate the coordinates of the position of the electronic apparatus 1 and may instead use the output from at least one of the GPS sensor 110, the terrestrial magnetism sensor 111, the atmospheric pressure sensor 112, the acceleration sensor 113, and the angular velocity sensor 114. (That is, any of the GPS sensor 110, the terrestrial magnetism sensor 111, the atmospheric pressure sensor 112, the acceleration sensor 113, and the angular velocity sensor 114 can be an example of the position sensor.)

The processor 120 in the embodiment described above registers one mountain climbing plan in the electronic apparatus 1 and may instead register a plurality of mountain climbing plans. When the number of mountain climbing plans registered in the electronic apparatus 1 is two or more, the processor 120 may allow the user to specify any one of the plurality of mountain climbing plans in advance.

The processor 120 in the embodiment described above carries out both the logging initiation process and logging termination process for one mountain climbing plan but may not carry out one of the processes or may allow the user to choose in advance whether or not the user omits at least one of the logging initiation process and logging termination process for one mountain climbing plan.

The processor 120 in the embodiment described above may not initiate the logging but may notify the user that the user should initiate the logging (function of avoiding a situation in which the user forgets to initiate the logging). Similarly, the processor 120 may not terminate the logging but may notify the user that the user should terminate the logging (function of avoiding a situation in which the user forgets to terminate the logging).

The processor 120 in the embodiment described above may allow the logging to be initiated only when a fixed condition is satisfied (for example, when the user passes a planned initiation position). Similarly, the processor 120 may allow the logging to be terminated only when a fixed condition is satisfied (for example, when the user passes a planned termination position).

### 3. Outline of Embodiment

(1) As described above, the sport activity recording apparatus (electronic apparatus 1) according to the present embodiment includes the clock 160, which measures time, the position sensor (GPS sensor 110), which calculates a position, and the processor 120, which initiates, when the measured time (current date and time) falls within a predetermined period including planned sport activity (mountain climbing) initiation time (period in which remaining period to planned initiation time is shorter than or equal to Ts1) (Y in step S220) and the calculated position (current position) falls within a predetermined area including a planned sport activity initiation position (area where distance to planned initiation position is shorter than or equal to D1) (Y in step S270), recording of the sport activity (logging associated with mounting climbing) (step S280).

That is, the processor 120 initiates the recording when the measured time falls within the predetermined period (when the time approaches the planned initiation time) and the calculated position falls within the predetermined area (when the position approaches the planned initiation position). Therefore, even when the user does not instruct the sport activity recording apparatus to initiate the recording, the recoding can be appropriately initiated. Further, since the processor 120 uses both a period and a position, the possibility of inappropriate initiation of the recording can be lowered as compared with a case where only a period or a position is used. The sport activity recording apparatus can therefore lower the possibility of a large amount of omission of recorded data on the sport activity (mountain climbing log data) and useless recording (useless electric power consumption).

(2) The processor 120 causes the position sensor to start operating (steps S240) when the measured time falls within the predetermined period (Y in step S220).

That is, the processor 120 causes the position sensor to start operating when the measured time falls within the predetermined period (when the time approaches the planned initiation time). The position recording can therefore be initiated, for example, after the position sensor starts operating and when the calculated position falls within the predetermined area (when the position approaches the planned initiation position).

(3) The processor 120 does not allow the position sensor to start operating (step S290) when the measured time does not fall within the predetermined period (N in step S220).

That is, the processor 120 does not allow the position sensor to operate when the measured time does not fall within the predetermined period (when the time has not so approached the planned initiation time that they are not close enough to each other). The operation of the position sensor can therefore be restricted when the time does not fall within the predetermined period (when the time has not so approached the planned initiation time that they are not close enough to each other).

(4) The processor 120 increases the frequency of the action of the position sensor (step S320) when the calculated position falls within an inclusion area (area where the distance to the planned initiation position is shorter than or equal to D2) that includes the predetermined area (Y in step S320).

That is, the processor 120 increases the frequency of the action of the position sensor when the calculated position falls within the inclusion area, which is wider than the predetermined area. The calculation of a position included in the predetermined area (evaluation of whether or not the position falls within the predetermined area) can be quickly performed as compared with a case where the frequency is not increased.

(5) The processor 120 does not initiate the recording of the sport activity when the calculated position falls within the inclusion area but does not falls within the predetermined area (N in step S270).

That is, the processor 120 does not initiate the recording unless the calculated position falls within the predetermined area even when the calculated position falls within the inclusion area. The recording (or useless electric power consumption) in the case where the calculated position does not fall within the predetermined area can therefore be avoided.

(6) The processor 120 evaluates whether or not the calculated position falls within the predetermined area at a predetermined frequency (in high-frequency mode) (step S320) when the calculated position falls within the inclusion area.

That is, the processor 120 evaluates whether or not the calculated position falls within the predetermined area at a predetermined frequency when the calculated position falls within the inclusion area. The possibility of failure to detect timing when the calculated position enters the predetermined area can therefore be lowered.

(7) The processor 120 reduces the frequency of the action of the position sensor (step S290) when the position calculated after the calculated position falls within the inclusion area does not fall within the inclusion area (when the position once fell within the inclusion area but is out of the inclusion area again) (N in step S310).

That is, the processor 120 reduces the frequency of the action of the position sensor even when the calculated position once fell within the inclusion area but when the position calculated afterward does not fall within the inclusion area. Useless action of the position sensor in the case where the calculated position does not fall within the inclusion area can therefore be avoided.

(8) Further, the sport activity recording apparatus (electronic apparatus 1) according to the present embodiment includes the clock 160, which measures time, the position sensor (GPS sensor 110), which calculates a position, and the processor 120, which terminates, when the measured time falls within a predetermined period including planned sport activity (mountain climbing) termination time (period in which remaining period to planned termination time is shorter than or equal to Te1) (Y in step S420) and the calculated position falls within a predetermined area including a planned sport activity termination position (area where distance to planned termination position is shorter than or equal to E1) (Y in step S440), recording of the sport activity (logging associated with mounting climbing) (step S450).

That is, the processor 120 terminates the recording when the measured time falls within the predetermined period (when the time approaches the planned termination time) and the calculated position falls within the predetermined area (when the position approaches the planned termination position). Therefore, even when the user does not instruct the sport activity recording apparatus to terminate the recording, the recoding can be appropriately terminated. Further, since the processor 120 uses both a period and a position, the possibility of inappropriate termination of the recording can be lowered as compared with a case where only a period or a position is used. The sport activity recording apparatus can therefore lower the possibility of a large amount of omission of recorded data on the sport activity (mountain climbing log data) and useless recording (useless electric power consumption).

(9) The processor 120 evaluates whether or not the calculated position falls within the predetermined area at a predetermined frequency (in high-frequency mode) (step S430) when the measured time falls within the predetermined period (Y in step S420).

That is, the processor 120 evaluates whether or not the calculated position falls within the predetermined area (whether or not the position has approached the planned termination position) at a predetermined frequency when the measured time falls within the predetermined period (when the time has approached the planned termination time). The possibility of failure to detect a situation in which the calculated position falls within the predetermined area (the calculated position has approached the planned termination position) can therefore be lowered.

(10) A target of the recording includes the position (latitude, longitude, and altitude) calculated at each point of time during the sport activity.

The sport activity recording apparatus can therefore use the position sensor to record the sport activity.

(11) The sport activity recording apparatus according to the present embodiment is attachable to a predetermined site of the user.

The user can therefore record the sport activity without the sport activity recording apparatus held by a hand.

(12) The predetermined site is an arm or a wrist.

The user can therefore use the electronic apparatus as if it were, for example, a wristwatch.

### 4. Other Variations

The invention is not limited to the embodiment described above, and a variety of variations are conceivable within the scope of the substance of the invention.

For example, in the embodiment described above, part of the function of the network server 4 may be incorporated in the information terminal 2 or the electronic apparatus 1, or part of the function of the information terminal 2 or the electronic apparatus 1 may be incorporated in the network server 4. Further, in the embodiment described above, part or entirety of the function of the electronic apparatus 1 may be incorporated in the information terminal 2, or part or entirety of the function of the information terminal 2 may be incorporated in the electronic apparatus 1.

The electronic apparatus 1 or the information terminal 2 may incorporate known functions of a smartphone, for example, a camera function, a call function, and a communication function.

The electronic apparatus 1 or the information terminal 2 may incorporate another sensing function (such as humidity sensor) of sensing at least part of the sport activity (including biological activity).

Examples of application of the electronic apparatus 1 or the information terminal 2 may include skiing (including cross-country skiing and ski jumping), running, bicycling, walking, tennis, swimming, dieting, rehabilitation as well as mountain climbing, and even skating, golf, baseball, soccer, motorcycling, motorsport, boating (speed boat race), sailing, trail running, paragliding, kite flying, dogsled race, and robot flying (radio control). Different items may be logged and the user may choose a logged item in accordance with the application of the electronic apparatus 1 or the information terminal 2.

The electronic apparatus 1 or the information terminal 2 can be configured as a wrist-worn-type electronic apparatus, an earphone-type electronic apparatus, a ring-type electronic apparatus, a pendant-type electronic apparatus, an electronic apparatus attached to a sport gear for use, a smartphone, a head mounted display (HMD), and a variety of other types of mobile information apparatus.

The electronic apparatus 1 or the information terminal 2 may notify the user of information in the form of image display, audio, vibration, or any other type of action or a combination of at least two of the image display, audio, and vibration.

In the embodiment described above, a GPS (global positioning system) is used, and a global navigation satellite system (GNSS) or any other system may instead be used. For example, one of or two or more of EGNOS (European Geostationary-Satellite Navigation Overlay Service), QZSS (Quasi Zenith Satellite System), GLONASS (GLObal NAvigation Satellite System), GALILEO, BeiDou (BeiDou Navigation Satellite System), and other satellite positioning systems may be used. Further, WAAS (Wide Area Augmentation System), EGNOS (European Geostationary-Satellite Navigation Overlay Service), or any other satellite-based augmentation system (SBAS) may be used as at least one of the satellite positioning systems.

The embodiment and the variations described above are presented by way of example, and the invention is not limited thereto. For example, the embodiment and any of the variations can be combined with each other as appropriate.

The invention encompasses substantially the same configuration as the configuration described in the embodiment (for example, a configuration having the same function, using the same method, and providing the same result or a configuration having the same purpose and providing the same effect). Further, the invention encompasses a configuration in which an inessential portion of the configuration described in the embodiment is replaced. Moreover, the invention encompasses a configuration that provides the same advantageous effects as those provided by the configuration described in the embodiment or a configuration that can achieve the same purpose as that achieved by the configuration described in the embodiment. Further, the invention encompasses a configuration in which a known technology is added to the configuration described in the embodiment.

What is claimed is:

1. A sport activity recording apparatus comprising:
a clock that measures time;
a position sensor that calculates a position; and
a processor that initiates, when the measured time falls within a predetermined period including planned sport activity initiation time and the calculated position falls within a predetermined area including a planned sport activity initiation position, recording of the sport activity.

2. The sport activity recording apparatus according to claim 1,
wherein the processor causes the position sensor to start operating when the measured time falls within the predetermined period.

3. The sport activity recording apparatus according to claim 2,
wherein the processor does not allow the position sensor to start operating when the measured time does not fall within the predetermined period.

4. The sport activity recording apparatus according to claim 2,
wherein the processor increases a frequency of action of the position sensor when the calculated position falls within an inclusion area that includes the predetermined area.

5. The sport activity recording apparatus according to claim 4,
wherein the processor does not initiate the recording of the sport activity when the calculated position falls within the inclusion area but does not falls within the predetermined area.

6. The sport activity recording apparatus according to claim 4,
wherein the processor evaluates whether or not the calculated position falls within the predetermined area at a predetermined frequency when the calculated position falls within the inclusion area.

7. The sport activity recording apparatus according to claim 4,
wherein the processor reduces the frequency of the action of the position sensor when the position calculated after the calculated position falls within the inclusion area does not fall within the inclusion area.

8. A sport activity recording apparatus comprising:
a clock that measures time;
a position sensor that calculates a position; and
a processor that terminates, when the measured time falls within a predetermined period including planned sport activity termination time and the calculated position falls within a predetermined area including a planned sport activity termination position, recording of the sport activity.

9. The sport activity recording apparatus according to claim 8,
wherein the processor evaluates whether or not the calculated position falls within the predetermined area at a predetermined frequency when the measured time falls within the predetermined period.

10. The sport activity recording apparatus according to claim 1,
wherein a target of the recording includes the position calculated at each point of time during the sport activity.

11. The sport activity recording apparatus according to claim 1,
wherein the sport activity recording apparatus is attachable to a predetermined site of a user.

12. The sport activity recording apparatus according to claim 11,
wherein the predetermined site is an arm or a wrist.

13. A sport activity recording method comprising
initiating, when time measured by a clock falls within a predetermined period including planned sport activity initiation time and a position calculated by a position sensor falls within a predetermined area including a planned sport activity initiation position, recording of the sport activity.

14. A sport activity recording method comprising
terminating, when time measured by a clock falls within a predetermined period including planned sport activity termination time and a position calculated by a position sensor falls within a predetermined area including a planned sport activity termination position, recording of the sport activity.
